(19) United States
(12) Patent Application Publication
(10) Pub. No.: US 2007/0165813 A1
(43) Pub. Date: Jul. 19, 2007

(54) Systems and Methods for Providing Sender-Based Routing

(76) Inventor: Ben Dean, Pleasanton, CA (US)

Correspondence Address: CARR & FERRELL LLP, 2200 GENG ROAD, PALO ALTO, CA, 94303, US

(21) Appl. No.: 11/622,665

(22) Filed: Jan. 12, 2007

Related U.S. Application Data
(60) Provisional application No. 60/759,131, filed on Jan. 13, 2006.

(51) Int. Cl. H04M 3/42

(52) U.S. Cl. 379/201.01

(57) ABSTRACT

A system and method for providing sender-based routing is provided. The method comprises assigning a unique identifier to a first user. A single communication address is associated with the first user and a second user. A communication from the first user is routed to the second user based on the single communication address and the unique identifier.

### CROSS-REFERENCE TO RELATED APPLICATIONS

The present application claims the priority benefit of U.S. provisional patent application No. 60/759,131 filed Jan. 13, 2006 and entitled “Systems and Methods for Providing Communications Features,” the disclosure of which is incorporated herein by reference.

### BACKGROUND OF THE INVENTION

1. Field of the Invention

The present invention relates generally to communications, and more particularly to systems and methods for providing sender-based routing.

2. Description of Related Art

Conventionally, users are connected to one another based on communication addresses assigned to the users. For example, a user calls a particular phone number to reach one or more users associated with the particular phone number. As another example, a user may send an electronic mail to one or more users associated with an electronic email address. Thus, any first user can contact a second user by using the communication address assigned to the second user.

Disadvantageously, the communication address can only be utilized to contact the user, or multiple users in some cases, associated with the particular communication address. Thus, each person or group of persons needs a unique communication address in order to be contacted through the system.

### SUMMARY OF THE INVENTION

The present invention provides a system and method for providing sender-based routing. In a method according to one embodiment, a unique identifier is assigned to a first user. A single communication address is associated with the first user and a second user. A communication from the first user is routed to the second user based on the single communication address and the unique identifier.

### BRIEF DESCRIPTION OF THE DRAWINGS

FIG. 1 illustrates a schematic diagram of an exemplary architecture for providing sender-based routing according to one embodiment;

FIG. 2 illustrates a schematic diagram of an exemplary architecture for providing sender-based routing over a voice network according to one embodiment;

FIG. 3 illustrates a schematic diagram of an exemplary architecture for providing sender-based routing over a voice network and/or a data network according to one embodiment;

FIG. 4 illustrates a flow diagram of an exemplary process for routing telephone calls based on a unique identifier associated with the sender according to one embodiment; and

FIG. 5 illustrates a flow diagram of an exemplary process for providing sender-based routing according to one embodiment.

### DETAILED DESCRIPTION

Systems and methods for providing sender-based routing are provided. Various communications may be communicated utilizing the sender-based routing discussed herein. The sender data may be collected and utilized to issue or assign a unique identifier to the sender. For example, the unique identifier may comprise a phone number, an email address, or any other information associated with the sender that may be utilized to uniquely identify the particular sender. A communication from the sender may then be routed to another subscriber or recipient (including one at a different receiving device or system) based on the unique identifier of the user and a communication address that the sender, or other user, enters.

Exemplary embodiments of the present invention may allow for effective allocation of addresses to parties (human or machine) involved in exchanging information. Through such embodiments, it becomes possible to limit the number of network addresses required to support a disproportionately large number of subscribers. As a single entity may not need or have a relationship with all other entities in any particular network, embodiments of the present invention may allow for saving of address space relative to already existing communication systems and networks. Wasteful allocation of addresses may result in depletion of address space as evidenced by area code splits, increases in phone number length, transition from IPv4 and IPv6, and utilization of Network Address Translation (NAT) in IPv4 networks.

Sender based routing, in accord with the present disclosed invention, allows (for example) a 10-digit based phone number system without issues related to scalability. In a typical prior art solution, a 10-digit number may be assigned to every subscriber. Thus, a network with 10 million subscribers would require 10 million 10-digit numbers. Embodiments of the presently disclosed invention, however, may require only a few hundred numbers while still satisfying the millions of subscribers to the network. By assigning numbers based on relationships between subscribers, and utilizing sender-based routing to support multiples relationships via a single network address, the system need only provide the number of unique addresses required to support the subscriber with the most relationships. Such relationship-based assignments are applicable to phone numbers (for both voice and SMS/text messaging communication), email addresses, instant messaging addresses, and various other communications and messaging utilities.

Rights management by both parties in an exchange occurring through an embodiment of the present invention may allow for the initiation and termination of the relationship. Such rights management may further allow for protection of anonymity and privacy. Control over anonymity and privacy settings may aide in the management and delivery of unsolicited ‘junk mail.’ Such privacy controls may also overcome the unfair advantage of an originating party who does not need to disclose an originating address to the recipient, which prevents the receiving party from contacting the originating party. Such a disadvantage also prevents the receiving party from selectively blocking a particular originating party.

These and other advantages and benefits may become evident to one of skill in the art through the practice of the presently disclosed invention.

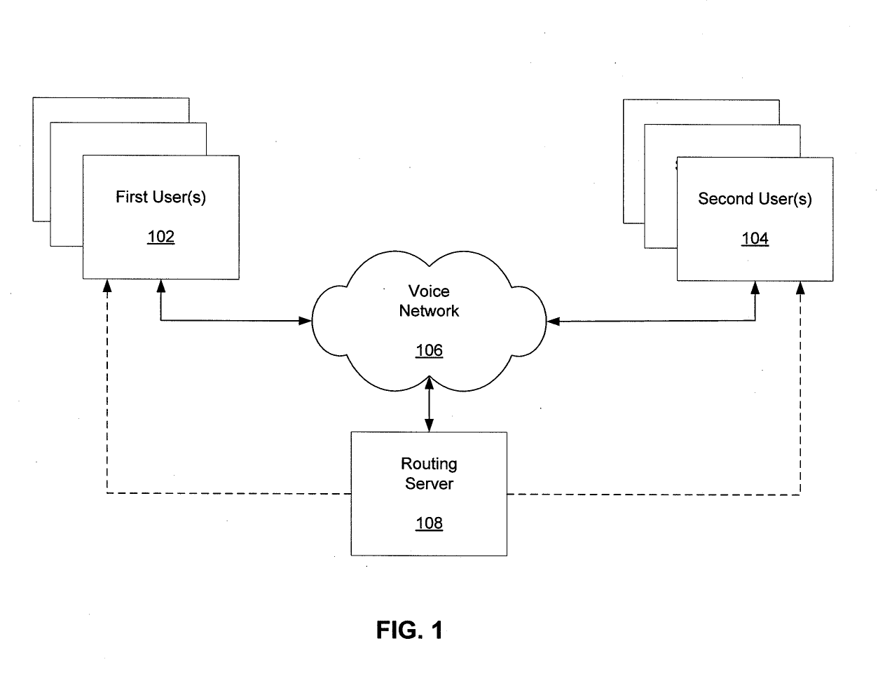

FIG. 1 illustrates a schematic diagram of an exemplary architecture for providing sender-based routing according to one embodiment. One or more first users 102 can communicate with one or more second users 104 via a voice network 106. The voice network 106 may include the public switched telephone network (PSTN), voice over IP (VoIP) or any other type of voice network 106 according to various embodiments.

A routing server 108 may be in communication with the voice network 106 for routing communications between the first user 102 and the second user 104. According to exemplary embodiments, the first user 102 sends a communication via the voice network 106. The voice network 106 recognizes a telephone number associated with the first user 102 as one of various telephone numbers that should be forwarded to the routing server 108. The routing server 108 identifies the first user 102 based on a unique identifier assigned to the first user 102. The routing server 108 then routes the communication to the second user 104 based on the telephone number entered and the unique identifier associated with the first user 102, or sender.

According to exemplary embodiments, the first user 102 and the second user 104 may each be assigned different communication addresses, such as telephone numbers, email addresses, and so forth. For example, the first user 102 and the second user 104 may each be assigned a local telephone number for one another. Thus, when the first user 102 calls the local telephone number, the communication is routed to the second user 104 based on the telephone number entered and the unique identifier associated with the first user 102, and vice versa. Accordingly, each of the first user 102 and the second user 104 can dial local phone numbers to reach one another.

In some embodiments, the voice network 106 includes the routing server 108 for directly routing the communications between the first user 102 and the second user 104. In other words, the voice network may forward communications to the routing server 108. The routing server 108 routes the communications between the first user 102 and the second user 104, or the voice network 106 may communicate with the routing server 108 in order to determine where the voice network 106 should route the communications.

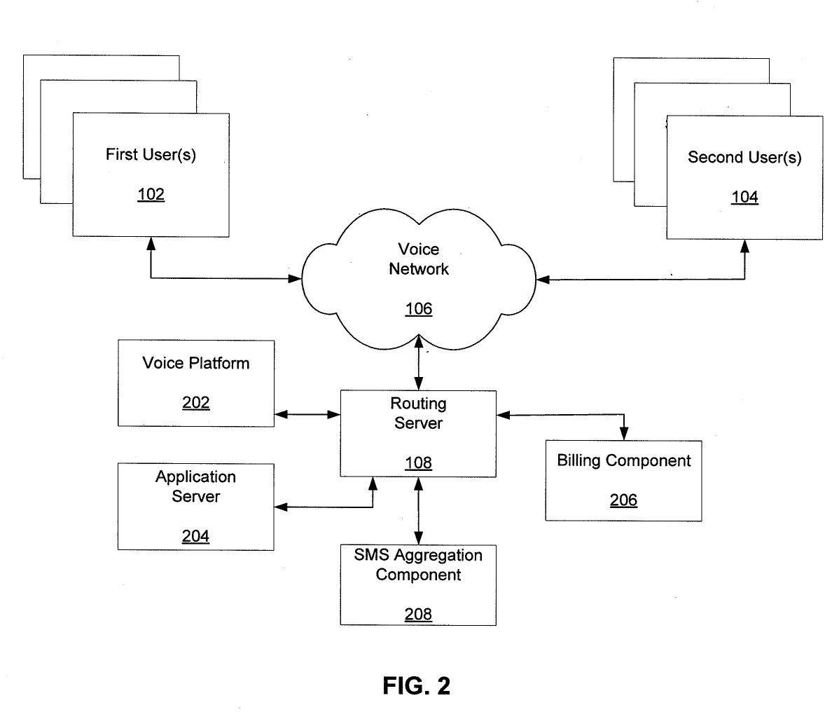

The routing server 108 may be coupled to one or more databases or storage mediums. The databases may include information regarding the relationship between the first user 102, the second user 104, and/or any other users along with the unique identifiers assigned to the first user 102, the second user 104, and/or any other users. Databases or other data storage for storing information associated with the one or more users is discussed further in association with FIGS. 2-5.

Referring now to FIG. 2, a schematic diagram of an exemplary architecture for providing sender-based routing over a voice network according to one embodiment is shown. As discussed herein, the first user 102 places a call (or generates any other communication that may be routed via the voice network 106) to the second user 104. Accordingly, the first user 102 is the sender. In other embodiments, the second user 104 may constitute the sender by initiating the call or other communication. The voice network 106 sends the call to the routing server 108 to be routed or consults the routing server 108 to determine where the call should be routed.

A voice platform 202 in communication with the routing server 108 provides voice services, such as speech recognition, interactive voice response (IVR), text-to-speech, and so forth. The voice platform 202 may also include a voice gateway for communicating voice communications to the routing server 108. Any components, servers, and so forth may be included as part of the voice platform 202 according to various embodiments.

An application server 204 in communication with the routing server 108 may be provided for providing various application services. For example, the application server 204 comprises one or more application servers, databases, and so forth. In exemplary embodiments, one or more databases or data storage, as discussed herein, may be provided for storing a subscriber directory that includes the unique identifiers for the senders, an application database, a logging database, a content database, and so forth. Any type of databases may be provided according to various embodiments.

A billing component 206 in communication with the routing server 108 may also be provided according to some embodiments. The billing component 206 may be utilized to assess charges accrued by the sender, such as the first user 102. According to exemplary embodiments, the billing component 206 provides billing data to the voice network 106. A party associated with the voice network 106 can then include the billing data on a bill issued for use of the voice network 106. In other embodiments, a party associated with the routing server 108 may issue a bill including the billing data directly to users, such as the first user 102 and/or the second user 104. Any type of billing system is within the scope of various embodiments.

An SMS aggregation component 208 may also be in communication with the routing server 108. The SMS aggregation component 208 processes text messages that are communicated to or from the first user 102 and/or the second user 104, according to exemplary embodiments.

In exemplary embodiments, the voice platform 202, the application server 204, and the routing server 108 comprise a sender-based routing system. However, any devices, components, and so forth may comprise the sender-based routing system according to other embodiments.

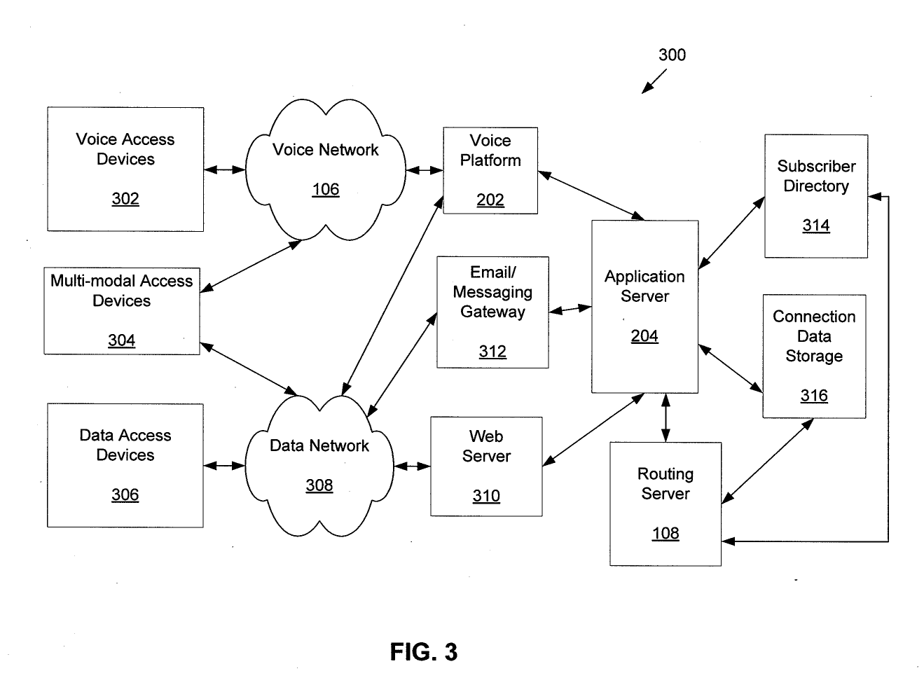

FIG. 3 illustrates a schematic diagram of an exemplary architecture for providing sender-based routing over a voice network and/or a data network according to one embodiment. Various voice access devices 302, such as a telephone, may be utilized to communicate voice communications via the voice network 106, as discussed herein. Thus, the first user 102 may utilize a voice access device 302 to call, text message, or otherwise communicate with the second user 104 via the voice network. In one embodiment, the voice network 106 routes the communication to the routing server 108 via the voice platform 202 and the application server 204.

The routing server 108 receives the communication and accesses a subscriber directory 314 to identify the sender based on the unique identifier issued to the sender, as discussed herein. The subscriber directory 314 may include various unique identifiers associated with each sender, each sender comprising a subscriber of the sender-based routing system 300.

A connection data storage 316 may be provided for storing various data about the various subscribers. For example, the connection data storage 316 may include a number of communication addresses associated with one subscriber, such as the first user 102. Accordingly, the application server 204 can utilize the unique identifier of the sender from the subscriber directory 314 to locate the communication address in the connection data storage 316. Using the unique identifier and the communication address, the application server 204 can communicate to the routing server 108 to which recipient, such as the second user 104, the call should be communicated.

Various data access devices 306, such as a laptop computer, and/or multi-modal access devices 304, such as a personal digital assistant, may be utilized to send data over a data network 308 utilizing the sender-based routing system 300 as well. A web server 310 may be provided as an interface for providing and updating data associated with the subscribers.

The web server 310 forwards the communication initiated by the data access device 306 and/or the multi-modal access device 304 to the application server 204. The application server 204 accesses the subscriber directory 314 and the connection data storage 316 to identify the sender and the intended recipient of the communication based on the unique identifier associated with the sender and the communication address entered via the data access device 306 or the multi-modal access device 304. The application server 204 instructs the routing server 108 where to route the communication.

Similarly, an email or other communication received via the data network 308 may be processed via an email/messaging gateway 312. The email or other communication is sent to the application server 204, which identifies the sender and the intended recipient by accessing information in the subscriber directory 314 and the connection data storage 316. The routing server 108 then routes the email or other communication to the appropriate recipient based on the data received from the application server 204.

Thus, the application server 204 determines the intended recipient of various communications received via the voice network 106 and/or the data network 308 and routes the various communications to the intended recipient via the voice network 106 and/or the data network 308. In some embodiments, the application server 204 receives communications via the voice network 106 and routes the communications to the intended recipient via the data network 308, and vice versa.

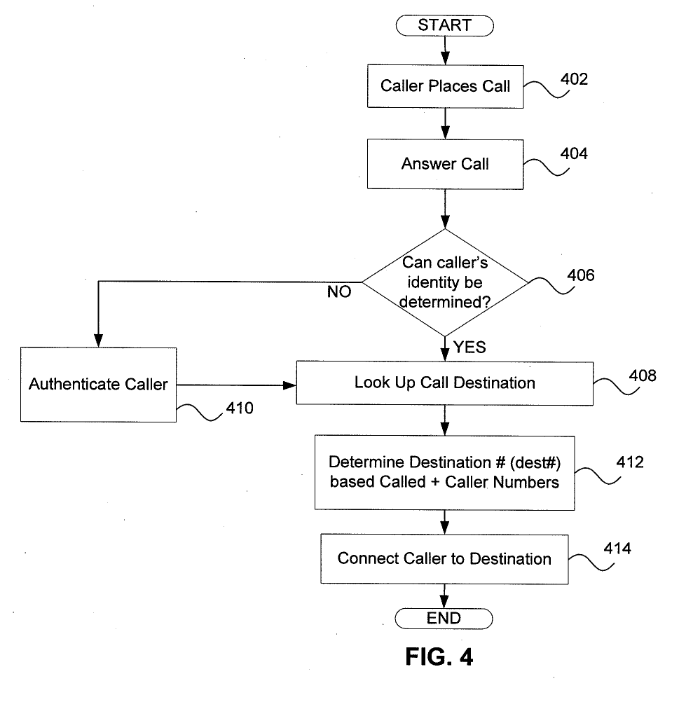

FIG. 4 shows a flow diagram of an exemplary process for routing telephone calls based on a unique identifier associated with the sender according to one embodiment. At step 402, a caller places a call. The caller may comprise the sender, as discussed herein, or any other user. According to FIG. 4, the caller places the call at step 402 by dialing a phone number. The phone number may comprise an anonymous phone number assigned to any number of users, as discussed herein.

At step 404, the call is answered. The call may be answered by the routing server 108 (FIG. 1) or by any other device or component. Once the call is answered, the routing server 108 or other device or component determines whether a caller's identity is available, at step 406. The caller ID may comprise the unique identifier associated with the caller, such as the sender. For example, the caller ID may comprise a phone number assigned to the caller placing the call. The caller's identity may be determined automatically, according to exemplary embodiments. The caller's identity may be determined from a caller ID program, voice printing, SIP authentication, and so forth. The phone number assigned to the caller may be stored in the subscriber directory 314 (FIG. 3) or any other data storage as discussed herein.

If the caller ID is available, the call destination is looked up at step 408. For example, the call destination may be looked up at the connection data storage 316 discussed in FIG. 3. The call destination may comprise an intended recipient for the call. For example, based on the unique identifier associated with the sender (i.e., caller) and a phone number dialed, the routing server 108 may determine to whom the call should be routed.

If the caller ID is not available at step 406, the caller is authenticated at step 410. Various methods may be employed for authenticating the caller at step 406. For example, the routing server 108 may request data from the caller in order to authenticate the caller. Any type of caller authentication process is within the scope of various embodiments. Once the caller is authenticated at step 410, the call destination is looked up at step 408, as discussed herein.

At step 412, the destination number is determined based on the number dialed, or otherwise entered, by the caller and the unique identifier, such as the caller's phone number, associated with the caller. More than one user, such as another caller or sender, may utilize the same number to initiate communication. However, the other caller or sender may be associated with a different unique identifier. Accordingly, the number dialed combined with the unique identifier associated with the caller can be utilized to determine the destination number so the caller can be connected with the intended recipient.

To illustrate, a first user, such as the first user 102 discussed in FIG. 1, may use a communication address, such as by calling a first telephone number, to establish a connection with a second user, such as the second user 104 discussed in FIG. 1. When the same first user 102 calls a second telephone number, a connection with a third user is established because the routing server 108 (FIG. 1) uses the unique identifier associated with the first user (i.e., the sender) and the telephone number called (i.e., the communication address) to route the call to the second user 104 using the first number and to the third user using the second number. A fourth user may also use the same first telephone number to establish a connection with a fifth user, or any other user, because the routing server 108 accesses data about each of the users that indicate the destination to which each of the users should be connected based on the unique identifier and the telephone number, for instance, to establish the appropriate connection.

At step 414, the caller is connected to the destination based on the destination number determined at step 412. Although the recipient may also be associated with a unique identifier, the routing server 108 can utilize the unique identifier associated with the caller and the number entered by the caller in order to determine the destination or intended recipient.

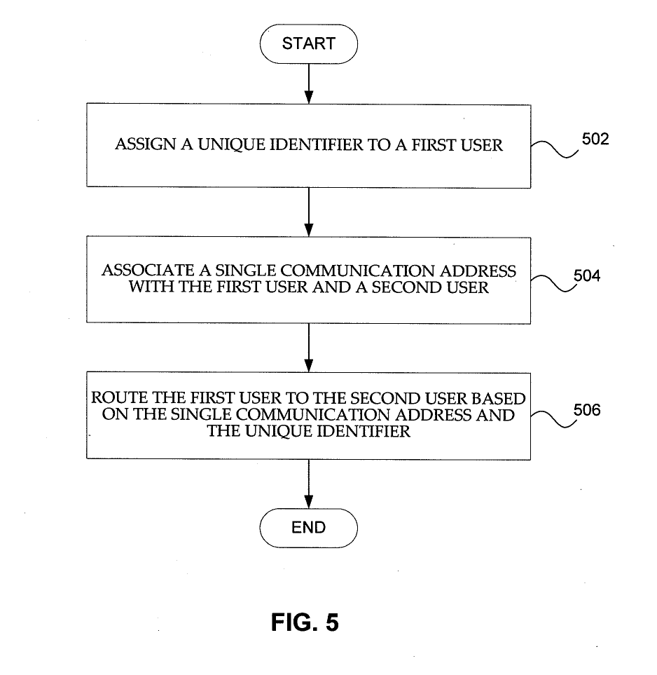

Referring now to FIG. 5, a flow diagram of an exemplary process for providing sender-based routing according to one embodiment is shown. At step 502, a unique identifier is assigned to, or otherwise associated with, a first user. As discussed herein, the unique identifier may comprise a communication address, such as a telephone number or email address, from which the first user communicates or any other type of unique identifier. For example, the unique identifier may be assigned to a user that comprises the sender or the caller discussed herein. Any type of user may comprise the first user 102 according to various embodiments.

At step 504, a single communication address is associated with the first user and a second user. The single communication address may comprise a telephone number, an email address, an instant message address, and so forth. The single communication address can comprise any address that may be utilized to allow communication between the first user and the second user. According to exemplary embodiments, a same single communication address may be assigned to more than the first user and the second user.

The routing server 108 (FIG. 1) or the application 204 (FIG. 2) may associate the single communication address with the first user and the second user. However, any device, party, component and so forth can associate the single communication address with the first user and the second user according to some embodiments. For example, a third party that represents the voice network 106 (FIG. 1) can associate the single communication address with the first user and the second user.

At step 506, a communication from the first user is routed to the second user based on the single communication address and the unique identifier. Thus, while other users may share the same single communication address, the combination of the single communication address and the unique identifier assigned to the first user indicates the destination to which a communication from the first user is routed. Accordingly, the first user may use one or more second single communication addresses to contact one or more third users.

Because the unique identifier associated with the first user combined with the single communication address determines the destination, the first user uses a different single communication address to contact the one or more third users. In other words, whenever the first user utilizes the first communication address, the first user is connected with, or otherwise in communication with, the second user. However, when the first user utilizes a second communication address, the first user is connected with a third user. Similarly, when the first user utilizes a third communication address, the first user is connected with a fourth user, and so forth.

According to alternate embodiments, the first user may be assigned more than one unique identifier. For example, a different unique identifier may be assigned to the first user for each recipient with which the first user wants to establish connections. In the alternate embodiments, the first user can utilize the same single communication address for various recipients (i.e., the second user, the one or more third users) and the communications may be routed to the various recipients based on the same single communication address and the different unique identifier assigned to the first user for each of the various recipients.

Although the routing server 108 is described as performing look up functions and routing the communications from the first user, such as the caller or the sender described herein, to the second user, any type of device or component may perform the same functions, or perform fewer or more functions, as those described in association with the routing server 108. For example, a third party may be utilized to route the first user to the second user based on information provided by the routing server 108.

According to some embodiments, data associated with a first user and a second user is received. For example, the routing server 108 may request registration data from the first user and the second user.

A single communication address is assigned to a combination of the first user and the second user. For example, a single telephone number may be assigned to the first user and the second user. The first user is then routed to the second user when the first user initiates a communication via the communication address. Thus, when the first user dials the phone number, the first user is routed to the second user. Similarly, the second user may be routed to the first user when the second user initiates a communication via the same communication address. Thus, if either the first user or the second user dials the telephone number assigned to the combination of the first user and the second user, the other party (i.e. the first user or the second user as the recipient) may be reached.

The first user and/or the second user is allowed to cancel the single communication address according to some embodiments. Thus, the first user and/or the second user can cut off or eliminate communication with the other party by canceling the communication address assigned to the first user and the second user. Further, because the single communication address is only assigned to the first user and the second user combination, the first user and the second user may remain anonymous to one another.

The routing server 108 can use a unique identifier associated with the first user and/or the second user to assign the same single communication address to various users. Thus, the routing server 108 determines that when the first user initiates communication utilizing the single communication address, the second user should be connected to the first user. When a third user utilizes the same communication address to initiate communication, however, the routing server 108 identifies the third user via the unique identifier and routes the third user to an intended recipient, such as a fourth user, which has been associated with the communication and the unique identifier. Accordingly, various pairs of users may be assigned the same single communication address. According to alternate embodiments, more than two users may be assigned the single communication address.

For example, users may be assigned different communications addresses with respect to communicating with different users. For example, a first user may be assigned a first address (e.g., 925-111-2222) for the purpose of reaching a second user. The second user may be assigned a second address (e.g., 925-333-4444) for the purpose of reaching the first user. A third user could be assigned the first address (i.e., 925-111-2222) for the purpose of reaching the second user and the second user could be assigned the second address (i.e., 925-333-4444) for the purpose of reaching the third user. Sender based routing, in such a scenario, allows for the re-use and effective allocation of addresses.

While various embodiments have been described above, it should be understood that they have been presented by way of example only, and not limitation. For example, any of the elements associated with the sender-based routing may employ any of the desired functionality set forth hereinabove. Thus, the breadth and scope of a preferred embodiment should not be limited by any of the above-described exemplary embodiments.

What is claimed is:

1. A method for providing sender-based routing, comprising:
assigning a unique identifier to a first user;
associating a single communication address with the first user and a second user; and
routing a communication from the first user to the second user based on the single communication address and the unique identifier.

2. The method recited in claim 1, wherein the single communication address comprises a phone number.

3. The method recited in claim 1, wherein the single communication address comprises an email address.

4. The method recited in claim 1, wherein the single communication address is associated with one or more other users.

5. The method recited in claim 1, wherein the single communication address comprises an instant message address.

6. The method recited in claim 1, further comprising instructing a third party to perform the step of routing the communication from the first user to the second user.

7. The method recited in claim 1, wherein the single communication address is assigned to one or more third users associated with one or more different unique identifiers.

8. A system for providing sender-based routing, comprising:
an application server configured to assign a unique identifier to a first user and to associate a single communication address with the first user and a second user; and
a routing server configured to route a communication from the first user to the second user based on the single communication address and the unique identifier.

9. The system recited in claim 8, wherein the single communication address comprises a phone number.

10. The system recited in claim 8, wherein the single communication address comprises an email address.

11. The system recited in claim 8, wherein the single communication address is associated with one or more other users.

12. The system recited in claim 8, wherein the single communication address comprises an instant message address.

13. The system recited in claim 8, wherein the routing server is further configured to instruct a third party to perform the step of routing a communication from the first user to the second user.

14. The system recited in claim 8, further comprising a subscriber directory for storing the unique identifier.

15. The system recited in claim 8, wherein the application server is further configured to assign the single communication address to one or more third users associated with one or more different unique identifiers.

16. A computer readable storage medium having embodied thereon a program including instructions for providing sender-based routing, comprising:
assigning a unique identifier to a first user;
associating a single communication address with the first user and a second user; and
routing a communication from the first user to the second user based on the single communication address and the unique identifier.

17. The computer readable storage medium recited in claim 16, wherein the single communication address comprises a phone number.

18. The computer readable storage medium recited in claim 16, wherein the single communication address comprises an email address.

19. The computer readable storage medium recited in claim 16, wherein the single communication address is associated with one or more other users.

20. The computer readable storage medium recited in claim 16, wherein the single communication address comprises an instant message address.

21. The computer readable storage medium recited in claim 16, further comprising instructing a third party to perform the step of routing a communication from the first user to the second user.

22. The computer readable storage medium recited in claim 16, wherein the single communication address is assigned to one or more third users associated with one or more different unique identifiers.

23. A method for providing anonymous, disposable communication addresses comprising:
receiving data associated with a first user and a second user;
assigning a single communication address to the first user and the second user; and
routing a communication from the first user to the second user when the first user initiates a communication via the communication address.

24. The method recited in claim 23, further comprising routing a communication from the second user to the first user when the second user initiates a communication via the communication address.

25. The method recited in claim 23, further comprising allowing the first user or the second user to cancel the single communication address.

26. A method for providing sender-based routing, comprising:
assigning a unique identifier to a first user and a second user;
associating a first communication address with the first user and a second communication address with the second user;
routing a communication from the first user to the second user based on the first communication address and the unique identifier; and
routing a communication from the second user to the first user based on the second communication address and the unique identifier.

27. The method recited in claim 26, wherein the first communication address and the second communication address comprise telephone numbers local to the first user and the second user.

28. The method recited in claim 26, wherein the first communication address and the second communication address are associated with one or more third users.
